(19) United States
(12) Patent Application Publication
(10) Pub. No.: US 2015/0030936 A1
(43) Pub. Date: Jan. 29, 2015

(54) COMPOSITE PARTICLES FOR ELECTROCHEMICAL DEVICE ELECTRODE, MANUFACTURING METHOD FOR COMPOSITE PARTICLES FOR ELECTROCHEMICAL DEVICE ELECTRODE, ELECTRODE MATERIAL FOR ELECTROCHEMICAL DEVICE, AND ELECTROCHEMICAL DEVICE ELECTRODE

(71) Applicant: ZEON CORPORATION, Tokyo (JP)

(72) Inventor: Taku Matsumura, Tokyo (JP)

(21) Appl. No.: 14/381,610

(22) PCT Filed: Dec. 27, 2012
(86) PCT No.: PCT/JP2012/083871

§ 371 Date: Aug. 28, 2014

(30) Foreign Application Priority Data
Feb. 29, 2012 (JP) 2012-043387

(51) Int. Cl. H01G 11/30; H01M 4/04; H01G 11/72; H01G 11/86; H01M 4/36; H01G 11/04

(52) U.S. Cl. CPC H01G 11/30; H01M 4/366; H01G 11/04; H01G 11/72; H01G 11/86; H01M 4/0419
USPC 429/235; 429/209; 361/502; 427/58; 252/182.1

(57) ABSTRACT

Composite particles for an electrochemical device electrode including an electrode active material and a binding agent and having surfaces thereof coated with an external additive A, wherein at least one kind of the external additive A has a powder resistance of less than 10 Ω·cm, and, in the case where three axial diameters of the external additive A are a length diameter L_{A}, a thickness t_{A}, and a width b_{A}, the length diameter L_{A} is 0.1 to 5 μm and a ratio (b_{A}/t_{A}) between the width b_{A} and the thickness t_{A} is 5 or more and less than 50.

### TECHNICAL FIELD

The present invention relates to composite particles which are to be used electrochemical device electrodes and have fluidity and excellent adhesiveness to current collectors, a manufacturing method for the composite particles for an electrochemical device electrode, an electrode material for an electrochemical device using the composite particles, and an electrochemical device electrode using the composite particles,

### BACKGROUND ART

It is expected that the demands for electrochemical devices having small-size, light-weight, high energy density, and repetitive charge-discharge capability such as a lithium ion secondary battery and an electric double layered capacitor will hereafter expand due to their environmental friendliness and the like. The lithium ion secondary battery is used in the fields of mobile phone, notebook type personal computer, and the like due to its high energy density, and the electric double layered capacitor is used as a small memory backup power source of a personal computer or the like due to its rapid charge-discharge capability. Also, a lithium ion capacitor utilizing an oxidation-reduction reaction of a surface of a metal oxide or an electroconductive polymer (pseudo electric double layered capacitor) is attracting attention due to its large capacity. There is a demand for further improvements in performance such as low resistance, large capacity, and so forth in these electrochemical devices because of expansion and development of usages.

As a manufacturing method for the electrodes for an electrochemical device, there has been proposed a method for obtaining an electrode by preparing a powder by spray-drying a slurry of an electrode composition including an electrode active material, an electroconductive material, and a binder and then pressure molding the powder (see Patent Literature 1, for example).

However, since a viscosity control agent is not used in Patent Literature 1, a viscosity of the slurry is low. Therefore, fluidity of the composite particles is deteriorated since the binder in the composite particles is localized on surfaces of the composite particles, and it has been difficult to manufacture an electrode having uniform film thickness. Accordingly, Patent Literature 2 proposes a method of coating surfaces of composite particles with an external additive.

Further, since it is preferable that the above-described composite particles efficiently adhere to a current collector, Patent Literature 3 proposes a method for obtaining an electrode for an electrochemical device by preparing composite particles using as an external additive a material capable of causing frictional electrification for enhancing coating efficiency on the current collector.

### CITATION LIST

### Patent Literatures

Patent Literature 1: JP 2004-247249 A
Patent Literature 2: US 2009/0267028 A1
Patent Literature 3: JP 2010-278125 A

### SUMMARY OF INVENTION

### Technical Problem

Meanwhile, the composite particles used for manufacturing the electrochemical device electrode more preferably have favorable adhesiveness to the current collector in addition to the fluidity. Also, the composite particles are required to have low internal resistance (hereinafter sometimes referred to as resistance for simplification purpose) when used for an electrochemical device.

An object of the present invention is to provide composite particles for an electrochemical device electrode having fluidity and favorable adhesiveness to current collectors as well as low resistance when used for an electrochemical device, a manufacturing method for the composite particles for an electrochemical device electrode, an electrode material for an electrochemical device using the composite particles for an electrochemical device electrode, and an electrochemical device electrode using the composite particles for an electrochemical device electrode.

### Solution to Problem

As a result of extensive research, the inventor found that it is possible to obtain composite particles for an electrochemical device electrode having fluidity and favorable adhesiveness to current collectors as well as low resistance when used for an electrochemical device by coating the composite particles with an external additive having a specific shape.

Therefore, according to the present invention, there are provided:

(1) composite particles for an electrochemical device electrode containing an electrode active material and a binding agent and having surfaces thereof coated with an external additive A, including: the external additive A has a powder resistance of less than 10 Ω·cm, and, when three axial diameters of the external additive A are a length diameter L_{A}, a thickness t_{A}, and a width b_{A}, the length diameter L_{A} is 0.1 to 5 μm and a ratio (b_{A}/t_{A}) between the width b_{A} and the thickness t_{A} is 5 or more and less than 50;

(2) the composite particles for an electrochemical device electrode according to (1), wherein a coating ratio coated with the external additive A is 0.1 to 20%;

(3) the composite particles for an electrochemical device electrode according to (1) or (2), wherein the composite particles are further coated with an external additive B, and, when three axial diameters of the external additive B are a length diameter L_{B}, a thickness t_{B}, and a width b_{B}, the length diameter L_{B} is 0.001 to 0.1 μm and a ratio (b_{B}/t_{B}) between the width b_{B} and the thickness t_{B} is 1 or more and less than 3, and a coating ratio coated with the external additive B is 0.01 to 0.2%;

(4) a method for manufacturing the composite particles for an electrochemical device electrode according to any of (1) to (3), including: a step (I) of obtaining a slurry by dispersing a mixture at least containing a binding agent and a solvent; a step (II) of obtaining composite particles by spray drying the slurry; and a step (III) of dry-mixing the composite particles with the external additive A, wherein an electrode active material is further added to the mixture in the step (I) or the slurry is dried by spraying the slurry to a fluidizing electrode active material in a heated air stream in the step (II);

(5) an electrode material for an electrochemical device including the composite particles for an electrochemical device electrode according to any of (1) to (3);

(6) an electrochemical device electrode including an active material layer including the electrode material for an electrochemical device according to (5) and a current collector on which the active material layer is laminated;

(7) the electrochemical device electrode according to (6), wherein the active material layer is laminated on the current collector by pressure molding; and

(8) the electrochemical device electrode according to (7), wherein the pressure molding is roller pressure molding.

### Advantageous Effects of Invention

According to the present invention, there are provided composite particles for an electrochemical device electrode having fluidity and favorable adhesiveness to current collectors as well as low resistance when used for an electrochemical device and a method for manufacturing the composite particles for an electrochemical device electrode as well as an electrode material for an electrochemical device using the composite particles for an electrochemical device electrode and an electrochemical device electrode using the composite particles for an electrochemical device electrode.

### DESCRIPTION OF EMBODIMENTS

Hereinafter, embodiments of the present invention will be described. Composite particles for an electrochemical device electrode of the present invention include an electrode active material and a binding agent and have surfaces thereof coated with an external additive A, wherein at least one kind of the external additive A has a powder resistance of less than 10 Ω·cm, and, in the case where three axial diameters of the external additive A are a length diameter L_{A}, a thickness t_{A}, and a width b_{A}, the length diameter L_{A} is 0.1 to 5 μm and a ratio (b_{A}/t_{A}) between the width b_{A} and the thickness t_{A} is 5 or more and less than 50.

### (Electrode Active Material)

The electrode active material to be used in the present invention may appropriately be selected depending on the type of an electrochemical device. In the case of using the composite particles of the present invention as an electrode material for a lithium ion secondary battery, a compound containing a transition metal, that is, an oxide containing a transition metal or a composite oxide of lithium and a transition metal, may be used as a positive electrode active material. Examples of the transition metal include cobalt, manganese, nickel, iron, and the like. Further, a polymer such as polyacetylene, poly-p-phenylene, polyquinone, or the like may be used.

Among these, the compound containing nickel or, particularly, the composite oxide containing lithium and nickel may suitably be used. The composite oxide containing lithium and nickel is suitably used because it has high capacity as compared to lithium cobaltate (LiCoO₂) that has heretofore been used as a positive electrode active material of lithium-based secondary batteries. Examples of the composite oxide containing lithium and nickel include those represented by the following general formula.

LiNi_{1-x-y}CoₓM_{y}O₂

(provided that 0≦x<1, 0≦y<1, x+y<1, and M is at least one element selected from B, Mn, and Al.)

Also, examples of an active material for a negative electrode as a counter electrode of the positive electrode of the lithium ion secondary battery include, for example, a carbonaceous material such as amorphous carbon, graphite, natural graphite, mesocarbon microbeads (MCMB), and a pitch-based carbon fiber; an electroconductive polymer such as polyacene; Si, Sn, Sb, Al, Zn, or W which is capable of alloyed with lithium; and the like. Note that the above-described electrode active materials may appropriately be used alone or in combination of a plurality of kinds thereof depending on the usage.

The shape of the electrode active material for lithium ion secondary battery electrodes may preferably be regulated to be particulate. With the spherical particle shape, it is possible to form an electrode having higher density when obtaining the electrode by molding.

An average particle diameter of the electrode active material for lithium ion secondary batteries may ordinarily be 0.1 to 100 μm, preferably 1 to 50 μm, more preferably 5 to 20 μm, for both of the positive and negative electrodes. Resistance when used for a lithium ion secondary battery is increased in the case where the average particle diameter is too large, while there is a tendency that durability of the battery is insufficient due to acceleration of decomposition of an electrolyte liquid in the case where the average particle diameter is too small.

Also, in the case of using the composite particles of the present invention as an electrode material for electric double layered capacitors, an allotrope of carbon is ordinarily used as the electrode active material. The electrode active material for electric double layered capacitors may preferably have a large specific surface area that enables to form an interface having a larger area than that expected to be formed with the weight of the electrode active material. More specifically, the specific surface area may ordinarily be within the range of 30 m²/g or more, preferably 500 to 5,000 m²/g, more preferably 1,000 to 3,000 m²/g. Specific examples of the carbon allotrope include active carbon, polyacene, a carbon whisker, graphite, and the like, and powders or fibers thereof may be used. Among these, the active carbon is preferred, and, more specific examples thereof include phenol-based, rayon-based, acryl-based, pitch-based, and coconut husk active carbons, and the like.

Further, as to the electrode active material, in the case of using the composite particles as an electrode material for lithium ion capacitors of the present invention, the above-described electrode active materials for electric double layered capacitors may be used as the positive electrode active material, and the above-described negative electrode active materials for lithium ion secondary batteries may be used as the negative electrode active material.

### (Binding Agent)

The binding agent to be used for the composite particles is not particularly limited insofar as it is a substance that binds the particles of the above-described electrode active material to each other. A suitably used binding agent is a dispersion type binding agent having a property of being dispersible into a solvent. Examples of the dispersion type binding agent include a polymer compound such as a silicon-based polymer, a fluorine-containing polymer, a conjugated diene-based polymer, an acrylate-based polymer, polyimide, polyamide, and polyurethane; preferred examples thereof include the fluorine-containing polymer, the conjugated diene-based polymer, and the acrylate-based polymer; and more preferred examples thereof include the conjugated diene-based polymer and the acrylate-based polymer. These polymers may be used alone or in combination of two or more kinds thereof to be used as the dispersion type binding agent.

The fluorine-containing polymer is the polymer including a monomer unit containing a fluorine atom. Specific examples of the fluorine-containing polymer include polytetrafluoroethylene, polyvinylidene fluoride, a tetrafluoroethylene-perfluoroalkyl vinyl ether copolymer, an ethylene-tetrafluoroethylene copolymer, an ethylene-chlorotrifluoroethylene copolymer, and a perfluoroethylene-propene copolymer. Among these, it is preferable that the binding agent contains polytetrafluoroethylene since such a binding agent more easily retains the electrode active material by fibrillation.

The conjugated diene-based polymer is a homopolymer of conjugated diene-based monomer or a copolymer obtainable by polymerization of a monomer mixture including a conjugated diene-based monomer or a hydrogenate of the homopolymer or the copolymer. As the conjugated diene-based monomer, it is preferable to use 1,3-butadiene, 2-methyl-1,3-butadiene, 2,3-dimethyl-1,3 butadiene, 2-chlor-1,3-butadiene, substituted straight chain conjugated pentadienes, substituted and side chain conjugated hexadienes, or the like, and it is more preferable to use 1,3-butadiene from the viewpoints of capabilities of improving flexibility and of enhancing resistance against cracking when used for an electrode. Further, two or more kinds of the conjugated diene-based monomers may be contained in the monomer mixture.

In the case where the conjugated diene-based polymer is the copolymer of the above-described conjugated diene-based monomer and a monomer copolymerizable with the conjugated diene-based monomer, examples of the copolymerizable monomer include an α,β-unsaturated nitrile compound, a vinyl compound having an acid component, and the like.

Specific examples of the conjugated diene-based polymer include a homopolymer of conjugated diene-based monomer such as polybutadiene and polyisoprene; an aromatic vinyl-based monomer-conjugated diene-based monomer copolymer such as a styrene-butadiene copolymer (SBR) which may optionally be carboxy-modified; a vinyl cyanide-based monomer-conjugated diene-based monomer copolymer such as an acrylonitrile-butadiene copolymer (NBR); hydrogenated SBR; hydrogenated NBR; and the like.

A content ratio of the conjugated diene-based monomer unit in the conjugated diene-based polymer may preferably be 20 to 60 wt %, more preferably 30 to 55 wt %. When the content ratio of the conjugated diene-based monomer unit is too large, there is a tendency that electrolyte liquid resistance is deteriorated in the case where a negative electrode is produced by coating a current collector with a slurry composition containing the binding agent. When the content ratio of the conjugated diene-based monomer unit is too small, there is a tendency that sufficient adhesion is not attained between an electrode active material contained in a slurry composition and a current collector in the case of coating the current collector with the slurry composition containing the binding agent.

The acrylate-based polymer is the polymer including a monomer unit derived from a compound [(meth)acrylic acid ester] represented by a general formula (1): CH₂═CR¹—COOR² (wherein R¹ represents a hydrogen atom or a methyl group; R² represents an alkyl group or a cycloalkyl group; and R² may further have an ether group, a hydroxyl group, a phosphate group, an amino group, a carboxyl group, a fluorine atom, or an epoxy group), more specifically, is a homopolymer of the compound represented by the general formula (1) or a copolymer obtainable by polymerization of a monomer mixture containing the compound represented by the general formula (1). Specific examples of the compound represented by the general formula (1) include (meth)acrylic acid (cyclo)alkyl ester such as methyl (meth)acrylate, ethyl (meth)acrylate, propyl(meth)acrylate, isopropyl(meth)acrylate, n-butyl (meth)acrylate, isobutyl(meth)acrylate, cyclohexyl(meth)acrylate, 2-ethylhexyl(meth)acrylate, isopentyl(meth)acrylate, isooctyl(meth)acrylate, isobonyl(meth)acrylate, isodecyl(meth)acrylate, lauryl(meth)acrylate, stearyl(meth)acrylate, and tridecyl(meth)acrylate; ether group-containing (meth)acrylic acid ester such as butoxyethyl(meth)acrylate, ethoxydiethyleneglycol(meth)acrylate, methoxydipropyleneglycol(meth)acrylate, methoxypolyethyleneglycol(meth)acrylate, phenoxyethyl(meth)acrylate, and tetrahydrofurfuryl(meth)acrylate; a hydroxyl group-containing (meth)acrylic acid ester such as 2-hydroxyethyl(meth)acrylate, 2-hydroxypropyl(meth)acrylate, 2-hydroxy-3-phenoxypropyl(meth)acrylate, and 2-(meth)acryloyloxyethyl-2-hydroxyethylphthalic acid; carboxylic acid-containing (meth)acrylic acid ester such as 2-(meth)acryloyloxyethylphthalic acid and 2-(meth)acryloyloxyethylphthalic acid; fluorine group-containing (meth)acrylic acid ester such as perfluorooctylethyl(meth)acrylate; phosphate group-containing (meth)acrylic acid ester such as ethyl phosphate(meth)acrylate; epoxy group-containing (meth)acrylic acid ester such as glycidyl(meth)acrylate; an amino group-containing (meth)acrylic acid ester such as dimethylaminoethyl(meth)acrylate; and the like.

These (meth)acrylic acid esters may be used alone or in combination of two or more kinds thereof. Among these, (meth)acrylic acid alkyl ester is preferred, and methyl (meth)acylate, ethyl (meth)acrylate, and n-butyl (meth)acrylate, or (meth)acrylic acid alkyl ester of which an alkyl group has 6 to 12 carbon atoms is more preferred. By selecting these, it is possible to suppress swelling when brought into contact with an electrolyte liquid, thereby enabling improvement in cycle property.

Also, in the case where the acrylate-based polymer is a copolymer of the compound represented by the above-described general formula (1) and a monomer which is copolymerizable with the compound, examples of the copolymerizable monomer include carboxylic acid esters having two or more carbon-carbon double bonds, an aromatic vinyl-based monomer, an amide-based monomer, olefins, a diene-based monomer, vinyl ketones, and a heterocycle-containing vinyl compound as well as an α,β-unsaturated nitrile compound and a vinyl compound having an acid component.

A content ratio of the (meth)acrylic acid ester unit in the acrylate-based polymer may preferably be 50 to 95 wt %, more preferably 60 to 90 wt %. By maintaining the content ratio of the (meth)acrylic acid ester unit within the above-specified range, it is possible to improve flexibility when used for an electrode, thereby enabling high resistance against cracking.

Among the above-described copolymerizable monomers, the aromatic vinyl-based monomer may preferably be used from the viewpoints that an electrode produced by using the binding agent is less subject to deformation and has high strength and that, when a slurry composition is coated on a current collector, sufficient adhesion is attained between the electrode active material contained in the slurry composition and the current collector. Examples of the aromatic vinyl-based monomer include styrene and the like.

Note that when a content ratio of the aromatic vinyl-based monomer is too large, there is a tendency that sufficient adhesion is not attained between the electrode active material contained in the slurry composition and the current collector when coating the current collector with the slurry composition. Also, when the content ratio of the aromatic vinyl-based monomer is too small, there is a tendency that electrolyte liquid resistance is deteriorated in the case where a negative electrode is produced by coating a current collector with the slurry composition.

Examples of the α,β-unsaturated nitrile compound to be used for the polymer forming the dispersion type binding agent include acrylonitrile, methacrylonitrile, α-chloroacrylonitrile, α-bromoacrylonitrile, and the like. These may be used alone or in combination of two or more kinds thereof. Among these, acrylonitrile and methacrylonitrile are preferred, and acrylonitrile is more preferred.

A content ratio of the α,β-unsaturated nitrile compound unit in the dispersion type binding agent may ordinarily be within the range of 0.1 to 40 wt %, preferably 0.5 to 30 wt %, more preferably 1 to 20 wt %. When the α,β-unsaturated nitrile compound unit is contained in the dispersion type binding agent, an electrode to be produced by using the binding agent is less subject to deformation and has high strength. Further, when the α,β-unsaturated nitrile compound unit is contained in the dispersion type binding agent, sufficient adhesion between the electrode active material contained in the slurry composition and the current collector is attained when the slurry composition is coated on the current collector.

Note that when the content ratio of the α,β-unsaturated nitrile compound unit is too large, there is a tendency that sufficient adhesion is not attained between the electrode active material contained in the slurry composition and the current collector when coating the current collector with the slurry composition. Also, when the content ratio of the α,β-unsaturated nitrile compound unit is too small, there is a tendency that electrolyte liquid resistance is deteriorated in the case where a negative electrode is produced by coating a current collector with the slurry composition.

Examples of the vinyl compound having acid component include acrylic acid, methacrylic acid, itaconic acid, maleic acid, fumaric acid, and the like. These may be used alone or in combination of two or more kinds thereof. Among these, acrylic acid, methacrylic acid, and itaconic acid are preferred, and methacrylic acid and itaconic acid are more preferred. From the viewpoint of enhancement of adhesive strength, it is particularly preferable to use methacrylic acid and itaconic acid in combination.

A content ratio of the vinyl compound unit having acid component in the dispersion type binding agent may ordinarily be 0.5 to 10 wt %, preferably 1 to 8 wt %, and more preferably 2 to 7 wt %. By maintaining the content ratio of the vinyl compound unit having acid component within the above-specified range, stability when used for the binder composition and the slurry composition is improved.

Note that when the content ratio of the vinyl compound unit having acid component is too large, viscosity of the binder composition is increased, and then there is a tendency that handling of the binder composition becomes difficult. Also, when the content ratio of the vinyl compound unit having acid component is too small, there is a tendency that stability of the binder composition and the slurry composition is reduced.

The form of the dispersion type binding agent is not particularly limited and may preferably be particulate. With the particulate dispersion type binding agent, a favorable binding property is attained, and it is possible to suppress a reduction in capacity of the produced electrode and deterioration due to repetitive charge-discharge. Examples of the particulate binding agent include those in a state where particles of a binding agent such as a latex are dispersed into water, a powder matter obtainable by drying such a dispersion liquid.

An average particle diameter of the dispersion type binding agent may preferably be 0.001 to 100 μm, more preferably 10 to 1000 nm, further preferably 50 to 500 nm, from the viewpoints of attaining favorable stability when used for a slurry and attaining favorable strength and flexibility of an electrode to be obtained.

Also, a method for producing the binding agent to be used in the present invention is not particularly limited, and a known polymerization method such as emulsion polymerization, suspension polymerization, dispersion polymerization, and solution polymerization may be employed. Among these, it is preferable to produce the binding agent by the emulsion polymerization since it is easy to control the particle diameter of the binding agent. Also, the binding agent to be used in the present invention may be particles having a core-shell structure obtainable by polymerizing two or more kinds of monomer mixtures in a stepwise manner.

An amount of the binding agent by dry weight relative to 100 parts by weight of the electrode active material may ordinarily be 0.1 to 50 parts by weight, preferably 0.5 to 20 parts by weight, more preferably 1 to 15 parts by weight. When the amount of the binding agent is within the above-specified range, it is possible to ensure sufficient adhesion between an electrode active material layer to be obtained and a current collector and, simultaneously, to suppress resistance.

### (Electroconductive Material)

The composite particles for an electrochemical device electrode of the present invention may contain an electroconductive material as required in addition to the above-described components.

The electroconductive material is not particularly limited and may be any electroconductive material insofar as it is electroconductive and in the form of particles, and examples thereof include electroconductive carbon black such as furnace black, acetylene black, and ketjen black; graphite such as natural graphite and artificial graphite; and a carbon fiber such as a polyacrylonitrile-based carbon fiber, a pitch-based carbon fiber, and a vapor grown carbon fiber. An average particle diameter of the electroconductive material is not particularly limited but may preferably be smaller than the average particle diameter of the electrode active material and may ordinarily be within the range of 0.001 to 10 μm, more preferably 0.05 to 5 μm, further preferably 0.01 to 1 μm. When the average particle diameter of the electroconductive material is within the above-specified range, sufficient electroconductivity is exhibited with a smaller amount of the electroconductive material to be used.

A content ratio of the electroconductive material in the composite particles for an electrochemical device electrode of the present invention may preferably be 0.1 to 50 parts by weight, more preferably 0.5 to 15 parts by weight, further preferably 1 to 10 parts by weight, relative to 100 parts by weight of the electrode active material. By maintaining the content ratio of the electroconductive material within the above-specified range, it is possible to maintain high capacity while satisfactorily reducing resistance of an electrochemical device to be obtained.

### (Dispersing Agent)

A dispersing agent may be contained in the composite particles as required. Specific examples of the dispersing agent include a cellulose-based polymer such as carboxymethyl cellulose, methyl cellulose, ethyl cellulose, and hydroxypropyl cellulose, ammonium salts and alkali metal salts of the cellulose polymers, alginic acid ester such as propylene glycol ester alginate, alginate such as sodium alginate, polyacrylate (or methacrylate) such as sodium polyacrylate (or methacrylate), polyvinyl alcohol, modified polyvinyl alcohol, polyethylene oxide, polyvinyl pyrrolidone, polycarboxylic acid, an acidified starch, a phosphoric acid starch, casein, various modified starches, chitin, a chitosan derivative, and the like. These dispersing agents may be used alone or in combination of two or more kinds thereof. Among these, the cellulose-based polymer is preferred, and the carboxymethyl cellulose or the ammonium salt or the alkali metal salt thereof is particularly preferred. An amount of the dispersing agent to be used is not especially limited insofar as the amount is within the range that does not impair the effects of the present invention and may ordinarily be within the range of 0.1 to 10 parts by weight, preferably 0.5 to 5 parts by weight, more preferably 0.8 to 2 parts by weight, relative to 100 parts by weight of the electrode active material.

### (Manufacture of Composite Particles)

The composite particles are obtainable by granulating components including the electrode active material, the binding agent, and such as the electroconductive material which is added as required. The composite particles at least include the electrode active material and the binding agent, and the components do not exist as independent particles, but each of the particles is formed of the two or more components including the constituent components such as the electrode active material and the binding agent. More specifically, a secondary particle is formed by binding of a plurality of the particles of the two or more components each substantially in a state of keeping its shape, and it is preferable that the plurality of particles (preferably several to several tens of particles) of the electrode active material are bound by the binding agent to form each of the particles.

The shape of each of the composite particles may preferably be substantially spherical from the viewpoint of fluidity. Specifically, when a short axis diameter of a composite particle is Lₛ, a long axis diameter of the composite particle is L₁, Lₐ=(Lₛ+L₁)/2, and sphericity (%) is a value of (1−(L₁−Lₛ)/Lₐ)×100, the sphericity may preferably be 80% or more, more preferably 90% or more. Here, the short axis diameter Lₛ and the long axis diameter L₁ are measured by using a scanning electron microscope photographic image.

An average particle diameter of the composite particles may ordinarily be within the range of 0.1 to 200 μm, preferably 1 to 80 μm, more preferably 10 to 40 μm. The average particle diameter of the composite particles maintained within the above-specified range is preferred since an active material layer having a desired thickness is easily obtained by the average particle diameter.

Note that, in the present invention, the average particle diameter means a volume average particle diameter which is measured and calculated by using a laser diffraction type particle size distribution measurement apparatus (for example, SALD-3100, Shimadzu Corporation).

Also, though a structure of the composite particles is not particularly limited, the structure in which the binding agent and the electroconductive material added as required are distributed on surfaces of the composite particles is preferred.

Though a method for manufacturing the composite particles is not particularly limited, it is possible to obtain the composite particles by a manufacturing method such as spray drying granulation, tumbling bed granulation, compression granulation, stirring granulation, extrusion granulation, pulverization granulation, fluidized bed granulation, fluidized bed multifunctional granulation, and a melt granulation.

The fluidized bed granulation includes a step of obtaining a slurry containing the binding agent and, as required, the electroconductive material, the dispersing agent, and other additives and a step of fluidizing the electrode active material into a heated air stream, spraying the slurry to the fluidizing electrode active material to bind and dry the electrode active material particles.

Also, the spray drying granulation described below is preferred since the method enables to relatively easily manufacture the composite particles in which the binding agent and the electroconductive material added as required are distributed in the vicinity of the surfaces of the composite particles. Hereinafter, the spray drying granulation will be described.

To start with, a slurry for composite particles containing the electrode active material and the binding agent is prepared. It is possible to prepare the slurry for composite particles by dispersing or melting the electrode active material, the binding agent, and the electroconductive material added as required into a solvent. Note that, in this case, when the binding agent is the one which is dispersed in water as a dispersion medium, the binding agent is added in the state of being dispersed in water.

Though water is ordinarily used as the solvent to be used for obtaining the slurry for composite particles, a mixture solvent of water and an organic solvent may also be used. Further, an organic solvent may be used alone, and several kinds of organic solvents may be used in combination. In this case, examples of the usable organic solvents include, for example, alkyl alcohols such as methyl alcohol, ethyl alcohol, and propyl alcohol, alkyl ketones such as acetone and methyl ethyl ketone, ethers such as tetrahydrofuran, dioxane, and diglyme, amides such as diethyl formamide, dimethyl acetamide, N-methyl-2-pyrrolidone, dimethyl imidazolidinone, and the like. Among these, the alcohols are preferred. By using water and the organic solvent having a boiling point lower than that of water in combination, a drying rate in the spray drying is increased. Further, since it is possible to adjust viscosity and fluidity of the slurry for composite particles by increasing the drying rate, production efficiency is improved.

Viscosity of the slurry for composite particles may preferably be within the range of 10 to 3,000 mPa·s, more preferably 30 to 1,500 mPa·s, further preferably 50 to 1,000 mPa·s, at a room temperature. When the viscosity of the slurry for composite particles is within the above-specified range, it is possible to improve the productivity of the spray drying granulation step.

Further, in the present invention, the dispersing agent and a surfactant may be added as required when preparing the slurry for composite particles. Examples of the surfactant include an anionic surfactant, a cationic surfactant, a nonionic surfactant, and an amphoteric surfactant such as a nonionic anion surfactant, and those which are easily heat-decomposed among the anionic and nonionic surfactants are preferred. A content of the surfactant may preferably be 50 parts by weight or less, more preferably 0.1 to 10 parts by weight, still more preferably 0.5 to 5 parts by weight, relative to 100 parts by weight of the electrode active material.

An amount of the solvent to be used in the slurry preparation is such that a solid content concentration of the slurry may ordinarily be within the range of 1 to 50 wt %, preferably 5 to 50 wt %, more preferably 10 to 30 wt %. The solid content concentration maintained within the above-specified range is preferred since the binding agent is uniformly dispersed into the slurry.

A method and an order for dispersing or dissolving the electrode active material, the binding agent, and the electroconductive material added as required into the solvent are not particularly limited, and examples thereof include a method in which the electrode active material, the electroconductive material, the binding agent, and the dispersing agent are added to a solvent and mixed, a method in which the dispersing agent is dissolved into a solvent, the binding agent (for example, latex) dispersed into a solvent is added to the solution, followed by mixing, and then the electrode active material and the electroconductive material are lastly added, followed by mixing, a method in which the electrode active material and the electroconductive material are added to the binding agent dispersed into a solvent, followed by mixing, and the dispersing agent dissolved into a solvent is added to the mixture, followed by mixing, and the like.

As a mixing apparatus, a ball mill, a sand mill, a bead mill, a pigment disperser, a grinder, an ultrasonic disperser, a homogenizer, a homomixer, a planetary mixer, or the like may be used. The mixing is ordinarily performed within the range of from a room temperature to 80° C. for 10 minutes to several hours.

Next, the obtained slurry for composite particles is granulated by spray drying. The spray drying is a method of drying the slurry by spraying the slurry into hot air. Examples of an apparatus used for spraying the slurry include an atomizer. Examples of the atomizer include two kinds of apparatuses, namely, a rotary disk type and pressurizing type, and the rotary disk type is the one by which the slurry is introduced into the substantially center of a disk rotating at high speed so that the slurry is sprayed when cast outside the disk by the centrifugal force of the disk. In the rotary disk type, a rotation speed of the disk may ordinarily be 5,000 to 30,000 rpm, preferably 15,000 to 30,000 rpm, though it depends on the size of the disk. The lower the rotating speed of the disk is, the larger the sprayed droplet becomes, and the larger the average particle diameter of the obtained composite particles becomes. Examples of the rotary disk type atomizer include pin type and vane types, and the pin type atomizer is preferred. The pin type atomizer is one of centrifugal force spraying apparatuses using a spraying plate, in which the spraying plate is formed of upper and lower mounting plates and a plurality of spraying rollers which are attachably/detachably disposed on a substantially concentric circle along a circumference of the mounting plates. The slurry for composite particles is introduced into the center of the spraying plate, is then deposited on the spraying rollers by the centrifugal force, moves outward on surfaces of the rollers, and finally departs from the roller surfaces to be sprayed. The pressurizing type is the one that dries the slurry for composite particles by spraying the slurry from a nozzle by pressurization.

A temperature of the slurry for composite particles to be sprayed ordinarily is at a room temperature and may have a higher temperature than the room temperature by heating. Also, a temperature of the hot air in the spray drying may ordinarily be 25 to 200° C., preferably 50 to 150° C., more preferably 80 to 120° C. In the spray drying method, a method of blowing the hot air is not particularly limited, and examples thereof include a mode in which the hot air and the spraying direction are in parallel with each other along a horizontal direction, a mode in which spraying is performed at a drying tower top portion so that the particles fall down with the hot air, a mode in which the sprayed droplets are brought into counterflow contact with the hot air, a mode in which the sprayed droplets initially flow in parallel with the hot air and then fall down by gravity to brought into counterflow contact with the hot air, and the like.

Note that, apart from the method of spraying the slurry for composite particles containing the electrode active material and the binding agent at once, a method of spraying a slurry containing the binding agent and other additives as required onto the fluidized electrode active material may be employed as the spraying method. The optimum method may appropriately be selected from the viewpoints of particle diameter controllability, productivity, reduction of the particle diameter distribution, and the like and depending on the components of the composite particles and the like.

According to the above, the step (I) and the step (II) in the method for manufacturing the composite device for an electrochemical device electrode of the present invention are carried out.

### (Production of Externally Coated Particles)

The composite particles for an electrochemical device electrode of the present invention (hereinafter sometimes referred to as externally coated particles) are obtainable by coating at least a part of a surface of each of the composite particles obtained by the above-described method with an external additive A.

### (External Additive A)

The external additive A to be used in the present invention is not particularly limited insofar as it is a material having electroconductivity, and a carbon material and an electroconductive ceramic may preferably be used as the external additive A. Examples of the carbon material include, for example, electroconductive carbon black such as furnace black, acetylene black, and ketjen black; graphite such as natural graphite and artificial graphite; and a carbon fiber such as a polyacrylonitrile-based carbon fiber, a pitch-based carbon fiber, and a vapor grown carbon fiber. As the carbon material, those having a small surface area such as 30 m²/g or less are preferred. Graphite is particularly preferred, and scaly graphite is more preferred. When the surface area is too large, decomposition of an electrolyte liquid is undesirably accelerated when an electrode is manufactured by using such a carbon material. The external additives A may be used alone or in combination of two or more kinds thereof.

A powder resistance of at least one of the external additives A to be used in the present invention may be less than 10 Ω·cm, preferably less than 5 Ω·cm, more preferably less than 1 Ω·cm. An excessively large powder resistance of the external additive A is not preferred since such a powder resistance leads to an increase in resistance. As a content ratio of the component having the powder resistance of less than 10 Ω·cm in the external additive A may preferably be 20 wt % or more, more preferably 50 wt % or more, particularly preferably 100 wt %. The carbon materials and the electroconductive ceramics that may be used as the external additives A usually have a powder resistance of less than 10 Ω·cm.

Note that, the powder resistance of the external additive A to be used in the present invention is obtained by measuring a resistance value using a powder resistance measurement system (MCP-PD51 Type, DIA Instruments) at a room temperature with a pressure of 10 MPa being continuously applied and calculating the powder resistance ρ (Ω·cm)=R×(S/d) based on a converged resistance value R (Ω), an area S (cm²) and a thickness d (cm) of a compressed carbon particle layer.

Also, a shape of the external additive A is such that, when three axial diameters of the external additive A are a length diameter L_{A}, a thickness t_{A}, and a width b_{A}, a ratio (b_{A}/t_{A}) between the width b_{A} and the thickness t_{A} may be 5 or more and less than 50, preferably 7 or more and less than 40, more preferably 10 or more and less than 30. By maintaining the above-specified range, an excellent balance between fluidity of the composite particles and resistance of an electrochemical device to be obtained is attained. Note that the fluidity improvement effect to be attained by the externally coated particles is lost when the ratio (b_{A}/t_{A}) between the width b_{A} and the thickness t_{A} is too large, while a sufficient electroconductive path is not formed on the surfaces of the externally coated particles when the ratio (b_{A}/t_{A}) between the width b_{A} and the thickness t_{A} is too small.

Further, from the viewpoint of ensuring sufficient fluidity of the externally coated particles, the length diameter L_{A} may be 0.1 to 5 μm, preferably 0.5 to 4 μm. A binding force among the externally coated particles is insufficient when the length diameter L_{A} is too large, while a sufficient electroconductive path is not formed on the surfaces of the externally coated particles when the length diameter L_{A} is too small.

The external additive A having the above-described shape is commercially available.

The external additive A is the one having the above-described predetermined powder resistance and shape, and an electrochemical device to be obtained by the externally coated particles of the present invention achieves favorable adhesion between the active material layer and the current collector, low resistance, and an excellent high temperature storage property.

Note that the length diameter, width, and thickness of the external additive A to be used in the present invention and an external additive B described later in this specification and to be used in the present invention are the values measured by using a scanning electron microscope photograph image.

Also, a coating ratio of the composite particles with the external additive A relative to a surface area of each of the composite particles (granulated particles) may ordinarily be 0.1 to 20%, preferably 0.5 to 10%, more preferably 0.8 to 5%, from the viewpoint of a favorable balance between the binding force among the externally coated particles and the fluidity. The binding force among the externally coated particles becomes insufficient when the coating ratio with the external additive A is too large, while there is a tendency that the effect to be attained by the external additive A is lost when the coating ratio with the external additive A is too small.

The coating ratio with the external additive A in the composite particles is calculated by the following expression. Note that, according to the expression, it is possible to set a desired coating ratio and to obtain an amount of the external additive A to be added. A coating ratio with the external additive B described below is also calculated in accordance with the following expression.

$$\frac{\sqrt{3}}{2} π \times \frac{{L}_{A}}{{R}_{G}} \times \frac{{D}_{G}}{{D}_{A}} \times {W}_{A} \qquad \{ Math . 1 \}$$

L_{A}: length diameter of external additive A
R_{G}: average particle diameter of granulated particles
D_{G}: tap density (measured in accordance with JIS 22512) of granulated particles
D_{A}: true specific gravity of external additive A
W_{A}: amount (by weight) of external additive A to be added when granulated particles is 100

In the case of using the above-described carbon materials and the electroconductive ceramics, for example, as the external additive A, an amount thereof to be added may ordinarily be within the range of 0.1 to 18 parts by weight, preferably 0.4 to 9 parts by weight, relative to 100 parts by weight of the composite particles. By using the external additive A within the above-specified range, it is possible to attain a desired coating ratio.

### (Step of Coating Composite Particles)

At least a part of each of the surfaces of the composite particles obtained as described above is coated with the external additive A to obtain the externally coated particles. Note that, in the present invention, “coat” means deposition of the external additive A on at least a part of each of the surfaces of the composite particles, and it is not necessary to coat the entire surface of each of the composite particles. A coating method is not particularly limited, and it is possible to attain the coating by mixing the composite particles with the external additive A by dry mixing. Particularly, it is preferable to perform the mixing by employing a method which is capable of uniformly mixing the composite particles with the external additive A and does not apply a strong sheering force to the composite particles so as to prevent breakage of the composite particles during the mixing.

Specific examples of the mixing method include container stirring using a rocking mixer, a tumbler mixer, or the like in which mixing is attained by shaking, rotation, or vibration of the container per se; mechanical stirring using a mixer in which a blade, a rotational plate, a screw, or the like for stirring is attached to a rotation shaft which is horizontal or vertical to the container, such as a horizontal cylindrical mixer, a V type mixer, a ribbon type mixer, a conical screw mixer, a high speed fluidizing type mixer, a rotary disk type mixer, and a high speed rotational blade mixer; airflow stirring utilizing a swirling airflow attained by a compressed gas for mixing a powder in a fluidized layer; and the like. Also, a mixer utilizing the mechanisms alone or in combination may be used.

Among the above, from the viewpoint of productivity, the mechanical stirring by the high speed rotational blade mixer (e.g., Henschel Mixer of Mitsui Miike Machinery Co., Ltd.) which is capable of reducing a stirring time and applying a relatively strong sheering force and the airflow stirring which is capable of continuous coating processing are preferred. In the case of using the high speed rotational blade mixer (Henschel mixer), the number of rotations may ordinarily be 1,000 to 2,500 rpm, preferably 1,500 to 2,000 rpm. When the rotation number is within the above-specified range, it is possible to obtain the externally coated particles of which surfaces are uniformly coated with the external additive A in a short time without damaging the above-described composite particle structure. A mixing time is not particularly limited and may preferably be 5 to 20 minutes. Further, a mixing temperature may ordinarily be within the range of from a room temperature to 100° C. It is possible to confirm whether or not the composite particles are broken and the surfaces thereof are coated with the external additive A by scanning electron microscopic observation. Thus, it is possible to obtain the externally coated particles in which at least a part of each of the surfaces is coated with the external additive A. The externally coated particles obtained as described above have fluidity, a favorable adhesive property to a current collector, and low resistance when used for an electrode.

In accordance with the above, it is possible to perform the step (III) in the method for manufacturing the composite device for an electrochemical device electrode of the present invention.

### (External Additive B)

In the composite particles for an electrochemical device electrode of the present invention, it is preferable to further coat the composite particles with an external additive B when coating the composite particles with the external additive A. A coating method is not particularly limited, and it is possible to attain the coating by adding the external additive B when mixing the composite particles with the external additive A as described above. The external additive B is not particularly limited and may preferably be a ceramic such as silica, alumina, titanium oxide, and zirconia, and it is more preferable to use silica.

Also, as a shape of the external additive B may preferably be such that a length diameter L_{B} is 0.001 to 0.1 μm and a ratio (b_{B}/t_{B}) between a width b_{B} and a thickness t_{B} is 1 or more and less than 3, when three axial diameters of the external additive B are the length diameter L_{B}, the thickness t_{B}, and the width b_{B}. An average particle diameter of the external additive B may preferably be smaller than the average particle diameter of the composite particles and may ordinarily be within the range of 0.01 to 0.1 μm, preferably 0.015 to 0.07 μm, more preferably 0.02 to 0.04 μm. The effect of the electroconductive path formed on the externally coated particle surfaces by the above-described external additive A is lost when the average particle diameter of the external additive B is too large, while the fluidity improvement effect to be attained by the externally coated particles becomes insufficient when the average particle diameter of the external additive B is too small. The external additive B having the above-described shape is commercially available.

Also, a coating ratio of the composite particles with the external additive B relative to a surface area of each of the composite particles may ordinarily be 0.01 to 0.2%, preferably 0.02 to 0.1%, from the viewpoint of a favorable balance between the binding force among the externally coated particles and the fluidity. The adhesive strength between the electrode active material contained in the slurry composition and the current collector in the case where the slurry composition is coated on the current collector becomes insufficient when the coating ratio with the external additive B is too large, while the fluidity improvement effect to be attained by the externally coated particles becomes insufficient when the coating ratio with the external additive B is too small.

In the case of using the above-described silica, for example, as the external additive B, an amount thereof to be added may ordinarily be within the range of 0.01 to 0.2 part by weight, preferably 0.02 to 0.1 part by weight, relative to 100 parts by weight of the composite particles. It is possible to attain a desired coating ratio by using the external additive B within the above-specified range.

### (Electrode Material for Electrochemical Device)

It is possible to use the above-described externally coated particles alone or in combination with another binding agent or another additive as required for the electrode material for an electrochemical device of the present invention. A content amount of the externally coated particles to be contained in the electrode material for an electrochemical device may preferably be 50 wt % or more, more preferably 70 wt % or more, further preferably 90 wt % or more.

As the other binding agent to be used as required, the above-described binding agent may be used, for example. It is unnecessary to separately add another binding agent when preparing the electrode material for an electrochemical device since the externally coated particles of the present invention already contains the binding agent, but the another binding agent may be added in order to further enhance the binding force among the externally coated particles. As the other binding agent, it is preferable to use a nonaqueous binder such as a silicon-based polymer, a fluorine-containing polymer, a conjugated diene-based polymer, and an acrylate-based polymer. Further, an amount of the another binding agent to be added may ordinarily be 0.3 to 8 parts by weight, preferably 0.4 to 7 parts by weight, more preferably 0.5 to 5 parts by weight, relative to 100 parts by weight of the electrode active material. Examples of the other additive include a molding auxiliary agent such as water and alcohol, and the molding auxiliary agent may be added in an amount that is appropriately selected so as not to impair the effects of the present invention.

### (Electrochemical Device Electrode)

In the electrochemical device electrode of the present invention, an active material layer including the electrode material for an electrochemical device is laminated on a current collector. As a material for a current collector, a metal, carbon, an electroconductive polymer, or the like may be used, for example, and the metal is suitably used. As the metal, copper, aluminum, platinum, nickel, tantalum, titanium, a stainless steel, and other alloys, or the like are ordinarily usable. Among these, from the viewpoints of electroconductivity and voltage resistance, copper, aluminum, or an aluminum alloy may preferably be used. Also, in the case where high voltage resistance is required, high purity aluminum disclosed in JP 2001-176757 A or the like may suitably be used. The current collector is in the form of a film or a sheet, and a thickness thereof may ordinarily be 1 to 200 μm, preferably 5 to 100 μm, more preferably 10 to 50 μm, though it may appropriately be selected depending on the object of the usage.

When laminating the active material layer on the current collector, the electrode material for an electrochemical device as the active material layer may be laminated on the current collector after being molded in the form of a sheet, but it is preferable to employ a method of pressure molding the electrode material for an electrochemical device directly on the current collector. Examples of the pressure molding method include roller pressure molding in which a roller type pressure molding apparatus provided with a pair of rollers is used, and the active material layer is molded on the current collector by feeding the electrode material for an electrochemical device to the roller type pressure molding apparatus using a feeder such as a screw feeder while transferring the current collector by the rollers, the one in which the electrode material for an electrochemical device is scattered on the current collector, and a thickness of the electrode material for an electrochemical device is adjusted by using a blade or the like, followed by molding using a pressurizing device, the one in which a metal mold is charged with the electrode material for an electrochemical device, and molding is performed by applying a pressure on the metal mold, and the like. Among these, the roller pressure molding is preferred. Particularly, since the composite particles for an electrochemical device electrode (externally coated particles) of the present invention have high fluidity, the high fluidity enables the molding by the roller pressure molding, thereby improving productivity.

A temperature in the roller pressure molding may ordinarily be 25 to 200° C., preferably 50 to 150° C., more preferably 80 to 120° C. By maintaining the temperature in the roller pressure molding within the above-specified range, sufficient adhesion between the active material layer and the current collector is achieved. Also, a linear pressure between the rollers during the roller pressure molding may ordinarily be 10 to 1000 kN/m, preferably 200 to 900 kN/m, more preferably 300 to 600 kN/m. By maintaining the linear pressure within the above-specified range, it is possible to improve uniformity of the thickness of the active material. Furthermore, a molding rate during the roller pressure molding may preferably be 0.1 to 20 m/min, more preferably 4 to 10 m/min.

In order to attain high capacity of the molded electrochemical device electrode by preventing a fluctuation in thickness and by increasing density of the active material layer, post-pressurization may further be performed as required. As a method of the post-pressurization, a pressing step using rollers is typically performed. In the roller pressing step, two columnar rollers are parallelly arranged in a vertical direction with a narrow gap and are rotated in reverse directions respectively, and the electrode is nipped between the rollers to be pressurized. In the post-pressurization, temperatures of the rollers may be adjusted by heating, cooling, or the like as required.

Since the composite particles for an electrochemical device electrode (externally coated particles) of the present invention are used for the active material layer, the electrochemical device electrode obtained as described above attains favorable adhesion between the active material layer and the current collector and enables to attain low resistance when used for a battery. Examples of the battery include, for example, a lithium ion secondary battery, an electric double layered capacitor, a lithium ion capacitor, and the like.

### EXAMPLES

The present invention will hereinafter be described in more details in conjunction with examples, but it should be understood that the present invention is not limited to the following examples and can be carried out with arbitrary alterations within the range which does not deviate from the gist of the present invention and a scope equivalent thereto. Note that “%” and “parts” indicating an amount in the following description are based on weight unless otherwise described. The properties in Examples and Comparative Examples are measured in accordance with the following methods.

### [Fluidity of Powder]

Fluidity was measured by using Powder Tester P-100 (Hosokawa Micron Group), and sieves having a mesh size of 250 μm, 150 μm, and 76 μm were set on a shaking table in this order from the top. 2 g of composite particles produced in each of Examples and Comparative Examples was carefully placed, and shaking was performed at a shaking width of 1.0 mm for a shaking time of 60 seconds. After stopping the shaking, a weight of the composite particles left in each of the sieves was measured. Also, an aggregation degree was calculated in accordance with the following expression, and evaluation was conducted in accordance with the following evaluation criteria. The evaluation results are shown in Table 1.

(amount of powder left in upper sieve)÷5 (g)×100 a

(amount of powder left in middle sieve)÷5 (g)×100×0.6 b

(amount of powder left in lower sieve)÷5 (g)×100×0.2 c

a+b+c=aggregation degree (%)

### Evaluation Criteria

A: 0% or more and less than 10%
B: 10% or more and less than 30%
C: 30% or more and less than 50%
D: 50% or more and less than 70%
E: 70% or more

### [Peel Strength]

Each of negative electrodes for a lithium ion secondary battery (test sample) produced in Examples and Comparative Examples was fixed with its negative electrode active material layer up, and a cellophane tape was attached on a surface of the test sample negative electrode active material layer. After that, a digital force gauge was mounted to a measurement stand (each manufactured by Imada Co., Ltd.) and a stress generated when peeling off the cellophane tape from one end of the test sample in a direction of 180° at a speed of 50 ram/min was measured by using the device. A peel strength was measured by performing the measurement for 10 times and calculating an average value of the measurements. Evaluation was conducted based on the following evaluation criteria, and the evaluation results are shown in Table 1. The larger value indicates the larger adhesion strength for the negative electrode.

### Evaluation Criteria

A: 12 N/m or more
B: 7 N/m or more and less than 12 N/m
C: 2 N/m or more and less than 7 N
D: less than 2 N/m

### [Resistance]

Coin type cell lithium ion secondary batteries were produced by using the negative electrodes for a lithium ion secondary battery produced in Examples and Comparative Examples and left to stand at a room temperature for 24 hours, and then a charge-discharge operation at a charge-discharge rate of 4.2 V and 0.1 C was performed. After that, the charge-discharge operation was conducted under the environment of −35° C., and a voltage (ΔV) at 10 seconds after the start of discharge was measured. Evaluation was conducted based on the following evaluation criteria, and the evaluation results are shown in Table 1. The smaller value indicates the smaller internal resistance and capability of high speed charge-discharge.

### Evaluation Criteria

A: less than 0.2 V
B: 0.2 V or more and less than 0.3 V
C: 0.3 V or more and less than 0.5 V
D: 0.5 V or more and less than 0.7 V
E: 0.7 V or more

### [High Temperature Storage Property]

Coin type cell lithium ion secondary batteries were produced by using the negative electrodes for a lithium ion secondary battery produced in Examples and Comparative Examples and left to stand at a room temperature for 24 hours, and then a charge-discharge operation at a charge-discharge rate of 4.2 V and 0.1 C was performed to measure an initial capacity C₀. After that, each of the lithium ion secondary batteries was charged to 4.2 V and stored at 60° C. for 14 days. After that, the charge-discharge operation at a charge-discharge rate of 4.2 V and 0.1 C was performed to measure a capacity C₁ after the high temperature storage. A high temperature storage property was detected by calculating a capacity change ratio represented by ΔC=(C₁/C₀)×100(%) and evaluated according to the following evaluation criteria. The evaluation results are shown in Table 1. As to the capacity change ratio, the larger value indicates the more excellent high temperature storage property.

### Evaluation Criteria

A: 85% or more
B: 70% or more and less than 85%
C: 60% or more and less than 70%
D: 50% or more and less than 60%
E: less than 50%

Composite particles, externally coated particles, positive electrodes for a lithium ion secondary battery, negative electrodes for a lithium ion secondary battery, and lithium ion secondary batteries of Examples and Comparative Examples were produced as described below.

### Example 1

### Production of Binding Agent

A 5 MPa pressure resistant container with a stirring machine was charged with 50 parts of styrene, 47 parts of 1,3-butadiene, 3 parts of methacrylic acid, 4 parts of sodium dodecylbenzenesulfonate, 150 parts of ion exchange water, 0.4 parts of t-dodecyl mercaptan as a chain transfer agent, and 0.5 parts of potassium persulfate as a polymerization initiator, followed by sufficient stirring and heating to 50° C. to start polymerization. The reaction was stopped by cooling when a polymerization conversion ratio reached to 96%, thereby obtaining a binding agent.

### (Production of Slurry Composition for Secondary Battery Negative Electrode)

As a negative electrode active material, 96 parts of artificial graphite (average particle diameter: 24.5 μm, distance between graphite layers (spacing (d value) between (002) planes detected by X-ray diffraction): 0.354 nm), 3.0 parts in terms of a solid content of the binding agent, and 1 part in terms of solid content of 1.5% aqueous solution of carboxymethyl cellulose as a dispersing agent (DN-10L, Daicel Corporation) were mixed, and, further, ion exchange water was added so that a solid content concentration became 20%, followed by mixing and dispersing, thereby obtaining a slurry. The slurry was subjected to spray drying granulation using a spray drier (Ohkawahara Kakoki Co., Ltd.) and a rotary disk type atomizer (diameter: 65 mm) at the number of rotations of 25,000 rpm, a hot air temperature of 150° C., and a particle recovery outlet temperature of 90° C. to obtain composite particles. An average particle diameter of the composite particles was 40 μm.

(Compositing with External Additive)

100 parts by weight of the composite particles, 2.3 parts of scaly graphite particles (SLP-6; Timcal Graphite & Carbon; length of length diameter L_{A}: 3.5 μm; ratio (b_{A}/t_{A}) between width b_{A} and thickness t_{A}: 15, powder resistance: 0.5 Ω·cm) as the external additive A, 0.03 parts of silica (TG7120; Cabot Corporation; length of length diameter L_{B}: 0.03 μm; ratio (b_{B}/t_{B}) between width b_{B} and thickness t_{B}: 1) as the external additive B were mixed by using a Henschel mixer (Mitsui Miike Machinery Co., Ltd.) for 10 minutes to obtain particles (externally coated particles) formed by depositing the external additives onto the composite particles. Note that a coating ratio with the external additive A was 2.0%, and a coating ratio with the external additive B was 0.03%.

### (Production of Negative Electrode)

Next, the obtained externally coated particles were supplied to rollers (roller temperature: 100° C., pressing linear pressure: 4.0 kN/cm) of a roller pressing machine (press-cutting roughened heat roller, Hirano Gikenkyogyo Co., Ltd.) and were molded into a sheet at a molding rate of 20 m/min, thereby obtaining a negative electrode for a lithium ion secondary battery having a thickness of 80 μm.

### (Production of Half Cell)

The negative electrode was cut to obtain a circular piece having a diameter of 15 mm, and a separator formed of a circular polypropylene porous film having a diameter of 18 mm and a thickness of 25 μm, a metal lithium to be used as a positive electrode, and an expanded metal were laminated in this order on a negative electrode active material layer side of the negative electrode, followed by housing the laminate in a stainless steel coin-shaped outer packaging (diameter: 20 mm, height: 1.8 mm, stainless steel thickness: 0.25 mm) provided with a polypropylene packing. An electrolyte liquid was injected into the packaging in such a manner as to leave no air trapped in the housing, and the outer packaging was fixedly covered with a stainless steel cap having a thickness of 0.2 mm via the polypropylene packing, followed by sealing the battery can, thereby giving a half cell (secondary battery) having a diameter of 20 mm and a thickness of about 2 mm to be used for measurement of initial capacity.

Note that, as the electrolyte liquid, a solution obtained by dissolving LiPF₆ at a concentration of 1 mol/L into a mixture solvent obtained by mixing ethylene carbonate (EC) and diethyl carbonate (DEC) at EC:DEC=1:2 (volume ratio at 20° C.) was used.

### (Productions of Electrode Composition for Positive Electrode and Positive Electrode)

To 95 parts of LiCoO₂ having a spinel structure as a positive electrode active material, PVDF (polyvinylidene fluoride) as a binding agent for electrode mixture layer was added in such an amount that a solid content thereof became 3 parts, and 2 parts of acetylene black and 20 parts of N-methylpyrrolidone were further added, followed by mixing in a planetary mixer to obtain a mixed slurry in the form of a slurry. The mixed slurry for positive electrode was coated on an aluminum foil having a thickness of 18 μm, followed by drying at 120° C. for 30 minutes. After that, roller pressing was performed to obtain a positive electrode for a lithium ion secondary battery having a thickness of 60 μm.

### (Production of Secondary Battery)

The positive electrode was cut to obtain a circular piece having a diameter of 13 mm, and the negative electrode was cut to obtain a circular piece having a diameter of 14 mm. Further, a separator provided with a porous film was cut to obtain a circular piece having a diameter of 18 mm. On an electrode mixture layer side of the positive electrode, the separator and the negative electrode were laminated in this order, and the laminate was housed in a stainless steel coin type outer packaging provided with a polypropylene packing. An electrolyte liquid (solvent: EC/DEC=1/2, electrolyte: LiPF₆ at concentration of 1 M) was injected into the housing in such a manner as to leave no air trapped in the packaging, and the outer packaging was fixedly covered with a stainless steel cap having a thickness of 0.2 mm via the polypropylene packing, followed by sealing the battery can, thereby giving a lithium ion secondary battery (coin cell CR 2032) having a diameter of 20 mm and a thickness of about 3.2 mm.

### Example 2

Composite particles, externally coated particles, a positive electrode for a lithium ion secondary battery, a negative electrode for a lithium ion secondary battery, and a lithium ion secondary battery were produced in the same manner as in Example 1 except for changing the type of the external additive A to scaly graphite particles (SFG-6; Timcal Graphite & Carbon; length of length diameter L_{A}: 3.7 μm; ratio (b_{A}/t_{A}) between width b_{A} and thickness t_{A}: 30; powder resistance: 1.0 Ω·cm).

### Example 3

Composite particles, externally coated particles, a positive electrode for a lithium ion secondary battery, a negative electrode for a lithium ion secondary battery, and a lithium ion secondary battery were produced in the same manner as in Example 1 except for changing the type of the external additive A to scaly graphite particles (SFG-10; Timcal Graphite & Carbon; length of length diameter L_{A}: 5.0 μm; ratio (b_{A}/t_{A}) between width b_{A} and thickness t_{A}: 10; powder resistance: 0.8 Ω·cm).

### Example 4

Composite particles, externally coated particles, a positive electrode for a lithium ion secondary battery, a negative electrode for a lithium ion secondary battery, and a lithium ion secondary battery were produced in the same manner as in Example 1 except for changing the amount of the external additive A to 0.46 parts. Note that a coating ratio with the external additive A was 0.4%.

### Example 5

Composite particles, externally coated particles, a positive electrode for a lithium ion secondary battery, a negative electrode for a lithium ion secondary battery, and a lithium ion secondary battery were produced in the same manner as in Example 1 except for changing the amount of the external additive A to 10.4 parts. Note that a coating ratio with the external additive A was 9.0%.

### Example 6

Composite particles, externally coated particles, a positive electrode for a lithium ion secondary battery, a negative electrode for a lithium ion secondary battery, and a lithium ion secondary battery were produced in the same manner as in Example 1 except for changing the amount of the external additive B to 0.18 part. Note that a coating ratio with the external additive B was 0.18%.

### Example 7

Composite particles, externally coated particles, a positive electrode for a lithium ion secondary battery, a negative electrode for a lithium ion secondary battery, and a lithium ion secondary battery were produced in the same manner as in Example 1 except for changing the amount of the external additive B to 0.01 parts. Note that a coating ratio with the external additive B was 0.01%.

### Example 8

Composite particles, externally coated particles, a positive electrode for a lithium ion secondary battery, a negative electrode for a lithium ion secondary battery, and a lithium ion secondary battery were produced in the same manner as in Example 1 except for changing the type of the external additive B to silica (MSP-009; Tayca Corporation; length of length diameter L_{E}: 0.08 μm; ratio (b_{B}/t_{B}) between width b_{B} and thickness t_{B}: 1).

### Example 9

Composite particles, externally coated particles, a positive electrode for a lithium ion secondary battery, a negative electrode for a lithium ion secondary battery, and a lithium ion secondary battery were produced in the same manner as in Example 1 except for changing the type of the external additive B to silica (MSP-010; Tayca Corporation; length of length diameter L_{B}: 0.007 μm; ratio (b_{B}/t_{B}) between width b_{B} and thickness t_{B}: 1).

### Comparative Example 1

Composite particles, externally coated particles, a positive electrode for a lithium ion secondary battery, a negative electrode for a lithium ion secondary battery, and a lithium ion secondary battery were produced in the same manner as in Example 1 except for changing the type of the external additive A to acetylene black (Denki Kagaku Kogyo Kabushiki Kaisha; product name: Denka Black Powder) (length of length diameter L_{A}: 0.035 μm; ratio (b_{A}/t_{A}) between width b_{A} and thickness t_{A}: 1.0; powder resistance: 0.2 Ω·cm).

### Comparative Example 2

Composite particles, externally coated particles, a positive electrode for a lithium ion secondary battery, a negative electrode for a lithium ion secondary battery, and a lithium ion secondary battery were produced in the same manner as in Example 1 except for changing the type of the external additive A to spherical graphite particles (length of length diameter L_{A}: 3.4 μm; ratio (b_{A}/t_{A}) between width b_{A} and thickness t_{A}: 1.5; powder resistance: 0.6 Ω·cm).

### Comparative Example 3

Composite particles, externally coated particles, a positive electrode for a lithium ion secondary battery, a negative electrode for a lithium ion secondary battery, and a lithium ion secondary battery were produced in the same manner as in Example 1 except for changing the type of the external additive A to a carbon nanotube (VGCF; Showa Denko K.K.; length of length diameter L_{A}: 20 μm; ratio (b_{A}/t_{A}) between width b_{A} and thickness t_{A}: 130; powder resistance: 0.6 Ω·cm).

### Comparative Example 4

Composite particles, externally coated particles, a positive electrode for a lithium ion secondary battery, a negative electrode for a lithium ion secondary battery, and a lithium ion secondary battery were produced in the same manner as in Example 1 except for changing the type of the external additive A to boehmite (BMM; Kawai Lime Industry Co., Ltd.; length of length diameter L_{A}: 1 μm; ratio (b_{A}/t_{A}) between width b_{A} and thickness t_{A}: 10; powder resistance: 10×10¹² Ω·cm) which is a non-electroconductive external additive.

### Comparative Example 5

Composite particles, externally coated particles, a positive electrode for a lithium ion secondary battery, a negative electrode for a lithium ion secondary battery, and a lithium ion secondary battery were produced in the same manner as in Example 1 except for not using any external additive A or external additive B.

### Comparative Example 6

Composite particles, externally coated particles, a positive electrode for a lithium ion secondary battery, a negative electrode for a lithium ion secondary battery, and a lithium ion secondary battery were produced in the same manner as in Example 1 except for changing the type of the external additive A to organic particles which are a non-electroconductive external additive (MP-2200; Soken Chemical & Engineering Co., Ltd.; length of length diameter L_{A}: 1 μm; ratio (b_{A}/t_{A}) between width b_{A} and thickness t_{A}: 1; powder resistance: 10×10¹⁵ Ω·cm).

TABLE 1

| | Example 1 | Example 2 | Example 3 | Example 4 | Example 5 |
|---|---|---|---|---|---|
| Type of external | Scaly | Scaly | Scaly | Scaly | Scaly |
| additive A | graphite; | graphite; | graphite; | graphite; | graphite; |
| | SLP-6; | SFG-6; | SFG-10; | SLP-6; | SLP-6; |
| | TIMCAL | TIMCAL | TIMCAL | TIMCAL | TIMCAL |
| Powder resistance | 0.5 | 1 | 0.8 | 0.5 | 0.5 |
| of external | | | | | |
| additive A (Ω · cm) | | | | | |
| Ratio between width | 15 | 30 | 10 | 15 | 15 |
| b_{A} and thickness t_{A} | | | | | |
| (b_{A}/t_{A}) | | | | | |
| Length diameter L_{A} | 3.5 | 3.7 | 5 | 3.5 | 3.5 |
| (μm) | | | | | |
| Coating ratio with | 2 | 2 | 2 | 0.4 | 9 |
| external additive A | | | | | |
| (%) | | | | | |
| Type of external | Silica; | Silica; | Silica; | Silica; | Silica; |
| additive B | TG7120 | TG7120 | TG7120 | TG7120 | TG7120 |
| | (Cabot) | (Cabot) | (Cabot) | (Cabot) | (Cabot) |
| Ratio between width | 1 | 1 | 1 | 1 | 1 |
| b_{B} and thickness t_{B} | | | | | |
| (b_{B}/t_{B}) | | | | | |
| Length diameter L_{B} | 0.03 | 0.03 | 0.03 | 0.03 | 0.03 |
| (μm) | | | | | |
| Coating ratio with | 0.03 | 0.03 | 0.03 | 0.03 | 0.03 |
| external additive B | | | | | |
| (%) | | | | | |
| Evaluation items | | | | | |
| Fluidity of powder | A | A | A | B | A |
| Peel strength | A | B | B | B | B |
| Resistance | A | A | A | A | A |
| High temperature | A | A | A | A | B |
| storage property | | | | | |

| | Example 6 | Example 7 | Example 8 | Example 9 |
|---|---|---|---|---|
| Type of external | Scaly | Scaly | Scaly | Scaly |
| additive A | graphite; | graphite; | graphite; | graphite; |
| | SLP-6; | SLP-6; | SLP-6; | SLP-6; |
| | TIMCAL | TIMCAL | TIMCAL | TIMCAL |
| Powder resistance | 0.5 | 0.5 | 0.5 | 0.5 |
| of external | | | | |
| additive A (Ω · cm) | | | | |
| Ratio between width | 15 | 15 | 15 | 15 |
| b_{A} and thickness t_{A} | | | | |
| (b_{A}/t_{A}) | | | | |
| Length diameter L_{A} | 3.5 | 3.5 | 3.5 | 3.5 |
| (μm) | | | | |
| Coating ratio with | 2 | 2 | 2 | 2 |
| external additive A | | | | |
| (%) | | | | |
| Type of external | Silica; | Silica; | Silica; | Silica; |
| additive B | TG7120 | TG7120 | MSP-009 | MSP-010 |
| | (Cabot) | (Cabot) | (Tayca | (Tayca |
| | | | Corporation) | Corporation) |
| Ratio between width | 1 | 1 | 1 | 1 |
| b_{B} and thickness t_{B} | | | | |
| (b_{B}/t_{B}) | | | | |
| Length diameter L_{B} | 0.03 | 0.03 | 0.08 | 0.007 |
| (μm) | | | | |
| Coating ratio with | 0.18 | 0.01 | 0.03 | 0.03 |
| external additive B | | | | |
| (%) | | | | |
| Evaluation items | | | | |
| Fluidity of powder | A | B | A | B |
| Peel strength | B | B | B | B |
| Resistance | B | A | B | A |
| High temperature | B | B | B | B |
| storage property | | | | |

| | Comparative | Comparative | Comparative |
|---|---|---|---|
| | Example 1 | Example 2 | Example 3 |
| Type of external | Acetylene | Spherical | Carbon |
| additive A | black; Denki | graphite | nanotube; |
| | Kagaku Kogyo | | VGCF; Showa |
| | Kabushiki | | Denko K.K. |
| | Kaisha | | |
| Powder resistance | 0.2 | 0.6 | 0.6 |
| of external | | | |
| additive A (Ω · cm) | | | |
| Ratio between width | 1 | 1.5 | 130 |
| b_{A} and thickness t_{A} | | | |
| (b_{A}/t_{A}) | | | |
| Length diameter L_{A} | 0.035 | 3.4 | 20 |
| (μm) | | | |
| Coating ratio with | 2 | 2 | 2 |
| external additive A | | | |
| (%) | | | |
| Type of external | Silica; | Silica; | Silica; |
| additive B | TG7120 | TG7120 | TG7120 |
| | (Cabot) | (Cabot) | (Cabot) |
| Ratio between width | 1 | 1 | 1 |
| b_{B} and thickness t_{B} | | | |
| (b_{B}/t_{B}) | | | |
| Length diameter L_{B} | 0.03 | 0.03 | 0.03 |
| (μm) | | | |
| Coating ratio with | 0.03 | 0.03 | 0.03 |
| external additive B | | | |
| (%) | | | |
| Evaluation items | | | |
| Fluidity of powder | C | A | D |
| Peel strength | C | B | D |
| Resistance | B | C | A |
| High temperature | C | D | C |
| storage property | | | |

| | Comparative | Comparative | Comparative |
|---|---|---|---|
| | Example 4 | Example 5 | Example 6 |
| Type of external | Platy | None | Organic |
| additive A | boehmite; | | particles; |
| | BMM; Kawai | | MP-2200; Soken |
| | Lime Industry | | Chemical & |
| | Co., Ltd. | | Engineering |
| | | | Co., Ltd. |
| Powder resistance | 10 × 10¹² | | 10 × 10¹⁵ |
| of external | | | |
| additive A (Ω · cm) | | | |
| Ratio between width | 10 | | 1 |
| b_{A} and thickness t_{A} | | | |
| (b_{A}/t_{A}) | | | |
| Length diameter L_{A} | 1 | | 1 |
| (μm) | | | |
| Coating ratio with | 2 | | 2 |
| external additive A | | | |
| (%) | | | |
| Type of external | Silica; | None | Silica; |
| additive B | TG7120 | | TG7120 |
| | (Cabot) | | (Cabot) |
| Ratio between width | 1 | | 1 |
| b_{B} and thickness t_{B} | | | |
| (b_{B}/t_{B}) | | | |
| Length diameter L_{B} | 0.03 | | 0.03 |
| (μm) | | | |
| Coating ratio with | 0.03 | | 0.03 |
| external additive B | | | |
| (%) | | | |
| Evaluation items | | | |
| Fluidity of powder | A | D | A |
| Peel strength | A | D | C |
| Resistance | D | D | C |
| High temperature | D | D | C |
| storage property | | | |

The above evaluation results show that all of the fluidity of powder, peel strength, resistance, and high temperature storage property are favorable in the cases where the powder resistance of the external additive A used for the externally coated particles is less than 10 Ω·cm, the length diameter L_{A} is 0.1 to 5 μm, and the ratio (b_{A}/t_{A}) between the width b_{A} and the thickness t_{A} is 5 or more and less than 50 when the three axial diameters of the external additive A are the length diameter L_{A}, the thickness t_{A} and the width b_{A}.

1. Composite particles for an electrochemical device electrode containing an electrode active material and a binding agent and having surfaces thereof coated with an external additive A, comprising:
the external additive A has a powder resistance of less than 10 Ω·cm, and, when three axial diameters of the external additive A are a length diameter L_{A}, a thickness t_{A}, and a width b_{A}, the length diameter L_{A} is 0.1 to 5 μm and a ratio (b_{A}/t_{A}) between the width b_{A} and the thickness t_{A} is 5 or more and less than 50.

2. The composite particles for an electrochemical device electrode according to claim 1, wherein a coating ratio coated with the external additive A is 0.1 to 20%.

3. The composite particles for an electrochemical device electrode according to claim 1, wherein the composite particles are further coated with an external additive B, and, when three axial diameters of the external additive B are a length diameter L_{B}, a thickness t_{B}, and a width b_{B}, the length diameter L_{B} is 0.001 to 0.1 μm and a ratio (b_{B}/t_{B}) between the width b_{B} and the thickness t_{B} is 1 or more and less than 3, and a coating ratio coated with the external additive B is 0.01 to 0.2%.

4. A method for manufacturing the composite particles for an electrochemical device electrode according to claim 1, comprising:
a step (I) of obtaining a slurry by dispersing a mixture at least containing a binding agent and a solvent;
a step (II) of obtaining composite particles by spray drying the slurry; and
a step (III) of dry-mixing the composite particles with the external additive A, wherein
an electrode active material is further added to the mixture in the step (I) or the slurry is dried by spraying the slurry to a fluidizing electrode active material in a heated air stream in the step (II).

5. An electrode material for an electrochemical device comprising the composite particles for an electrochemical device electrode according to claim 1.

6. An electrochemical device electrode comprising an active material layer including the electrode material for an electrochemical device according to claim 5 and a current collector on which the active material layer is laminated.

7. The electrochemical device electrode according to claim 6, wherein the active material layer is laminated on the current collector by pressure molding.

8. The electrochemical device electrode according to claim 7, wherein the pressure molding is roller pressure molding.

9. The composite particles for an electrochemical device electrode according to claim 2, wherein the composite particles are further coated with an external additive B, and, when three axial diameters of the external additive B are a length diameter L_{B}, a thickness t_{B}, and a width b_{B}, the length diameter L_{B} is 0.001 to 0.1 μM and a ratio (b_{B}/t_{B}) between the width b_{B} and the thickness t_{B} is 1 or more and less than 3, and a coating ratio coated with the external additive B is 0.01 to 0.2%.

10. A method for manufacturing the composite particles for an electrochemical device electrode according to claim 2, comprising:
a step (I) of obtaining a slurry by dispersing a mixture at least containing a binding agent and a solvent;
a step (II) of obtaining composite particles by spray drying the slurry; and
a step (III) of dry-mixing the composite particles with the external additive A, wherein
an electrode active material is further added to the mixture in the step (I) or the slurry is dried by spraying the slurry to a fluidizing electrode active material in a heated air stream in the step (II).

11. A method for manufacturing the composite particles for an electrochemical device electrode according to claim 3, comprising:
a step (I) of obtaining a slurry by dispersing a mixture at least containing a binding agent and a solvent;
a step (II) of obtaining composite particles by spray drying the slurry; and
a step (III) of dry-mixing the composite particles with the external additive A, wherein
an electrode active material is further added to the mixture in the step (I) or the slurry is dried by spraying the slurry to a fluidizing electrode active material in a heated air stream in the step (II).

12. An electrode material for an electrochemical device comprising the composite particles for an electrochemical device electrode according to claim 2.

13. An electrode material for an electrochemical device comprising the composite particles for an electrochemical device electrode according to claim 3.
